(19) United States
(12) Patent Application Publication
(10) Pub. No.: US 2003/0098851 A1
(43) Pub. Date: May 29, 2003

(54) Pointing means for a computer

(76) Inventor: Soren Brink, Knebel (DK)

Correspondence Address: DYKEMA GOSSETT PLLC, FRANKLIN SQUARE, THIRD FLOOR WEST, 1300 I STREET, NW, WASHINGTON, DC, 20005, US

(21) Appl. No.: 10/203,458

(22) PCT Filed: Feb. 7, 2001
(86) PCT No.: PCT/DK01/00083

(30) Foreign Application Priority Data
Feb. 10, 2000 (DK) PA 2000 00210

(51) Int. Cl. G09G 5/08

(52) U.S. Cl. 345/163

(57) ABSTRACT

The invention relates to a pointing means for a computer and to a method of achieving a position of rest for a person who operates a pointing means, said pointing means being ergonomically shaped to fill a human hand. The object of the invention is to avoid injuries by the use of the pointing means for a computer by ensuring that the joints, muscles and tendons of the hand and the arm are not strained unnecessarily in use. The pointing means may be constructed so that the thumb engages a recess (6) which is a lengthwise recess (6) with a thumb supporting face (20) having thumb support on a first side (22) and a second opposite side (24) where the recess (6) can have an extension supporting the thumb as well as engagement means (10) for the ball of the thumb. It is ensured hereby that the hand is in a position of rest while the pointing means is operated. The pointing means fills the hand, and the actual movement of the pointing means is performed by the forearm and the wrist. The muscles and tendons of the hand remain in the position of rest during operation of the pointing means. Mouse injuries can be prevented hereby.

### DESCRIPTION

The invention relates to a pointing means for a computer, said pointing means consisting of a movement sensor having at least one button, said pointing means being ergonomically shaped to fill a human hand, said pointing means having engagement means for the thumb on one side, said side forming at least one side face on a projection, said projection having on at least one opposite face engagement means for the other fingers of the hand.

When using traditional mice, the hand is placed on top of the mouse, and movement of the mouse takes place by a lateral movement of the wrist and by movement of the forearm. Lateral movement of the wrist is an unnatural movement, which stresses joints, tendons and muscles. This causes mouse injuries in a large number of mouse users.

U.S. Pat. No. 5,576,733 discloses an upright ergonomic mouse having an engagement face for fingers on the side of the pointing means, the opposite side of the pointing means having an engagement face for the thumb so that the hand grasps the pointing means.

However, there is no support for the thumb, and the distance between the forefinger and the thumb is too wide for the hand to be in an optimum position of rest. No support for the thumb ball results in a great energy consumption of the thumb itself when the pointing means is to be moved. Because the pointing means is not shaped optimally, unnecessary strain on the user's muscles, tendons and joints may take place in normal use, and mouse injuries may occur.

The object of the invention is to avoid injuries when using a pointing means for a computer by ensuring that the joints, tendons and muscles of the hand and the arm are not strained unnecessarily in use.

The object may be achieved with a pointing means like the one described above, if it is configured such that the thumb engages a lengthwise recess with a thumb supporting face having thumb support on a first side and a second opposite side where the recess can have an extension supporting the thumb as well as engagement means for the ball of the thumb.

This ensures that the hand is in a position of rest while the pointing means is operated. Muscles, tendons and joints are hereby strained minimally. The pointing means fills the hand, and the actual movement of the pointing means is performed by the forearm and the wrist. The muscles and tendons of the hand remain in the position of rest during operation of the pointing means. Mouse injuries can hereby be prevented.

If a inclination line to the opposite face with engagement means for the other fingers of the hand is drawn, this line may advantageously form a first angle, relative to a horizontal face, which is between 60 and 105 degrees. The natural position of the hand may hereby be used in the operation of the pointing means.

The angle between the opposite face with engagement means for the other fingers of the hand, relative to a horizontal face may, in a preferred embodiment of the invention, be between 65.5 and 85.5 degrees. This results in a position of rest for the hand in which all muscles and tendons are relaxed, and in which the natural movement of the wrist is utilized when the pointing means is moved. Movement of the pointing means may then take place by means of the forearm and the wrist with minimum strain on muscles, tendons and joints.

The recess in one area in at least one level of cut can have a shape approximately like a sector of a circle. This recess can have a depth of at least the same size as the radius of the sector of a circle, and said recess can have an access opening of at least the same size as the diameter of the sector of a circle.

Easy entry for a thumb can be achieved hereby when the hand is placed on the pointing means, and correspondingly the pointing means may be released by lifting the thumb and simultaneously stretching the other fingers. The hand can with a pointing means shaped like this, be supported and be in its natural position during operation.

The recess of the thumb additionally has a recess which accommodates a scroll wheel which may be operated by the thumb, said scroll wheel simultaneously serving as a push-button. The thumb may hereby be used for two functions more, thereby reducing strain on muscles, tendons and joints.

Advantageously, the pointing means may be formed with an anatomically correct engagement face for the thumb ball. The thumb ball may hereby be supported and the thumb ball may be used for moving the pointing means.

The body of the pointing means may be formed with a projection which separates the thumb and the forefinger. It is hereby possible to avoid activating the gripping function of the hand, which will otherwise strain muscles, tendons and joints. The hand is fixed in the position of rest, whereby the hand remains in an energy-neutral angle.

The pointing means may also be formed with a depression for receiving the little finger. Hereby also the little finger can assume a relaxed position, and when the pointing means is to be moved, the little finger can participate in the work and thereby relieve the other fingers.

The pointing means may be provided in a version for both the right hand and the left hand. The pointing means can hereby also be used by persons who prefer the left hand for mouse operation.

The pointing means may be provided with means for wireless data transfer to a connected computer. The pointing means may hereby be employed without the use of a cable.

The pointing means may be provided in various sizes adapted to the size of a user's hand. The pointing means may hereby be adapted optimally to the user.

The invention may also be described as a method of achieving a position of rest for a hand of a person who operates a pointing means for a computer, wherein the hand is placed on the pointing means which is configured in consideration of the position of rest of the hand, wherein the pointing means is also formed with a recess for the engagement of the thumb, whereby the hand is placed in a neutral energy angle, and wherein movement of the pointing means takes place by movement of the forearm and by volar or dorsal flexion of the wrist.

The invention will be explained below with reference to drawings, in which:

FIG. 1 shows the pointing means seen obliquely from above and from behind,

FIG. 2 shows the pointing means seen from the external side,

FIG. 3 shows the pointing means seen obliquely from above and from the front,

FIG. 4 shows the pointing means seen obliquely from above and from the internal side,

FIG. 5 shows a right hand seen in an outer position for optimum rest,

FIG. 6 shows a right hand seen in another outer position for optimum rest,

FIG. 7 shows, like FIG. 3 the pointing means seen obliquely from above and from the front, but with a cut plane,

FIG. 8 shows the pointing means from the back, and

FIG. 9 is a fragmentary sectional view through the body of the pointing means, in the cut plane in FIG. 7, and shows recess and external thumb support.

### DESCRIPTION OF DRAWINGS

FIG. 1 shows the pointing means from the visual angle which is most common, viz. approximately the way it is positioned on the table relative to the user. The body 4 of the pointing means is formed by a plurality of faces. FIG. 1 shows a top face 2 which forms a high projection 18 ensuring that the necessary distance between thumb and forefinger is maintained so that these remain in a position of rest. To the left of the projection 18 below the top face 2 there is a recess 6 which extends right out to the thumb and provides full support for it. The thumb ball rests on a supporting face 10, which is an essential factor for the achievement of an optimum position of rest.

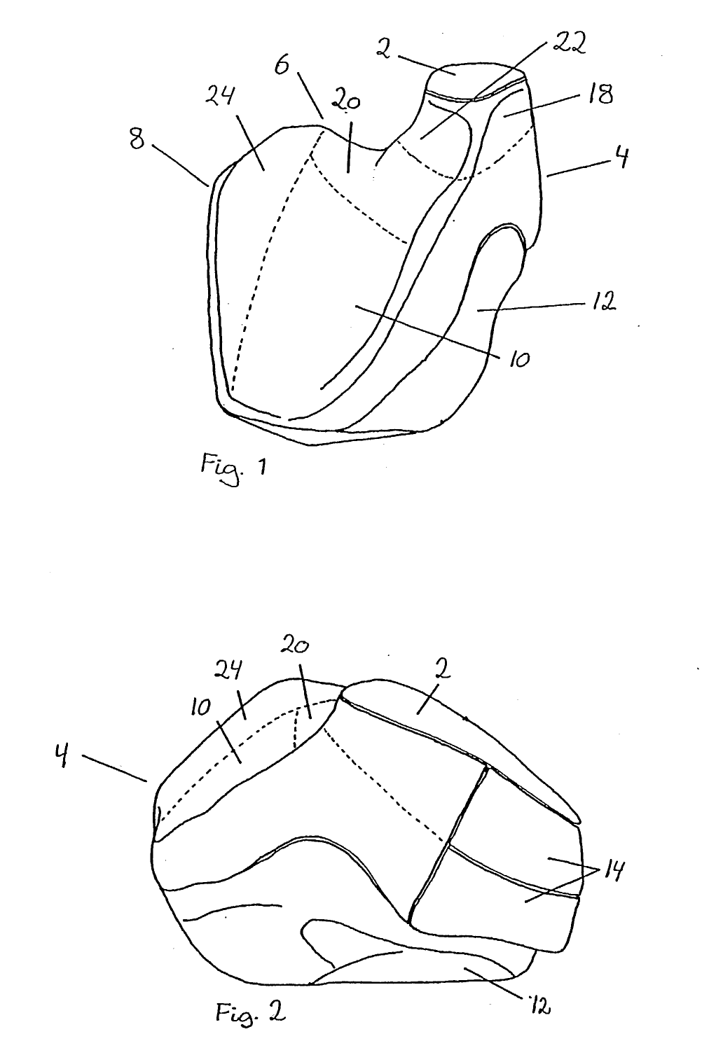

FIG. 2 shows the pointing means from the external side. It shows inter alia the top face 2, mouse buttons 14 and a depression 12 for the little finger.

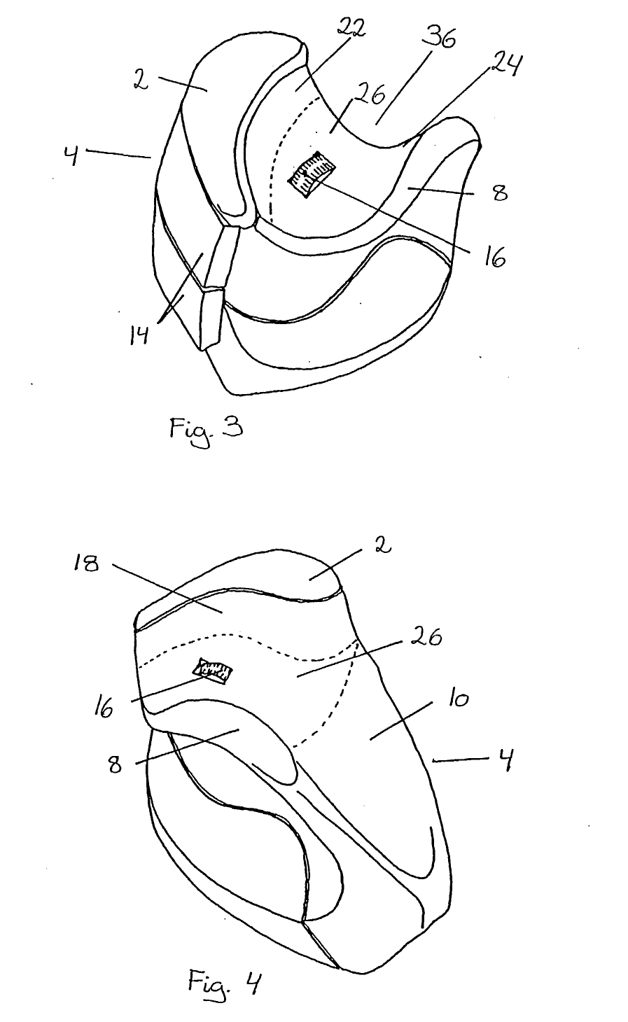

The mouse buttons 14 are supplemented by a scroll wheel 16, see FIGS. 3 and 4, which can also serve as a mouse button and is positioned in the recess 6 for the thumb.

It will be seen clearly in FIG. 3 that the recess 6 for the thumb is surrounded by the mouse body 4 on the one side 22 and on the second side 24 by an external thumb support 8 which almost form sides around the thumb.

FIGS. 5 and 6 show a right hand in outer positions for optimum rest. Within these positions no stationary energy is used for keeping the hand in a specific position. The hand is in a neutral energy position.

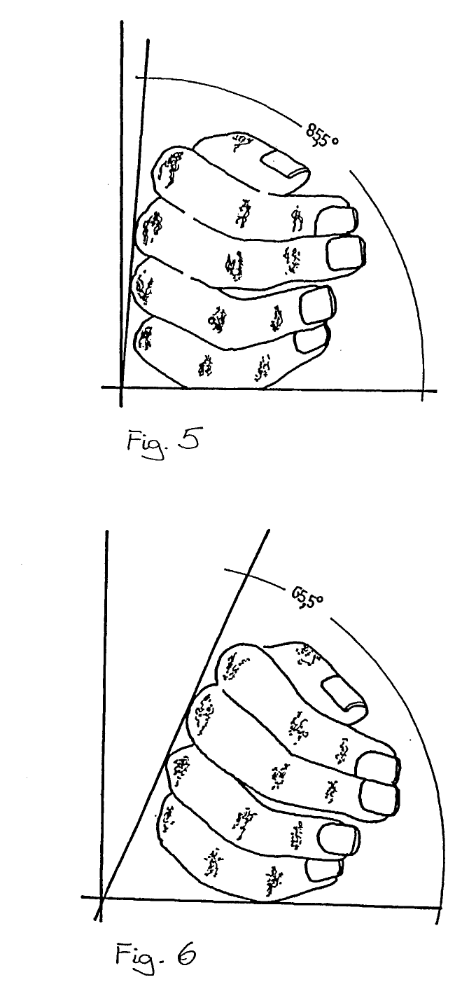

FIG. 7 shows a mouse, held by a human hand, with a cut plane, 28 placed in an area 26, approximately in the middle of the thumb.

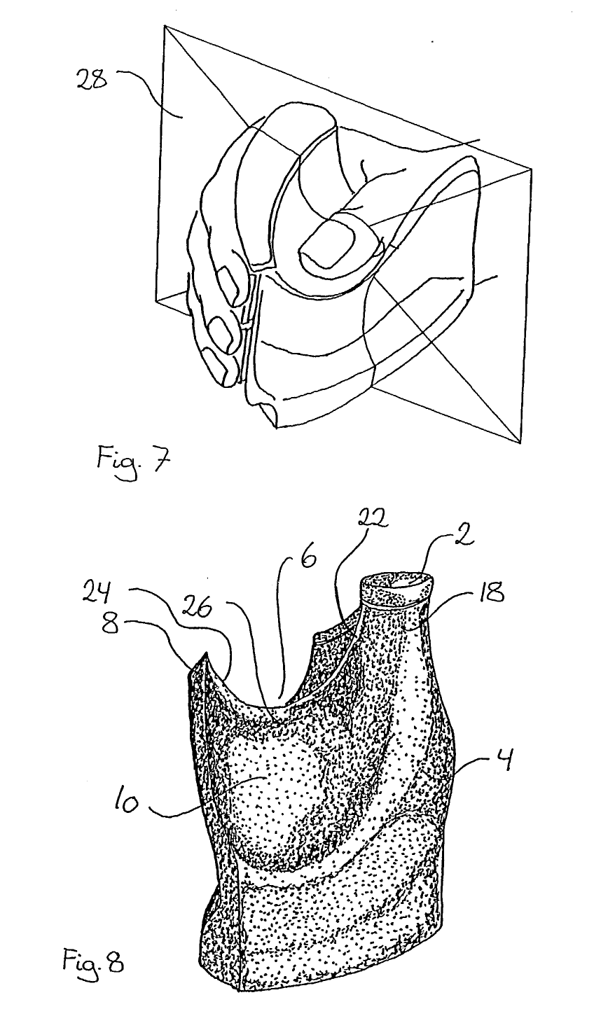

In FIG. 8 the mouse is shown from behind. In the drawing the thumb supporting face 20, the first side 22 and the second side 24 is clearly seen. Also the projection 18 and the engagement means 10 for the ball of the thumb is seen.

FIG. 9 shows an embodiment of the recess 6 and the external thumb support 8. The figure also shows the first thumb supporting side 22 as well as the second thumb supporting side 24 of the recess 6. The dot-dash line between the top face 2 and the external thumb support 8 indicates how the depth 34 of the recess 6 is defined. The recess 6 of the thumb has an entry opening 36 for the thumb with a opening of at least the same size as the diameter of the recess 6.

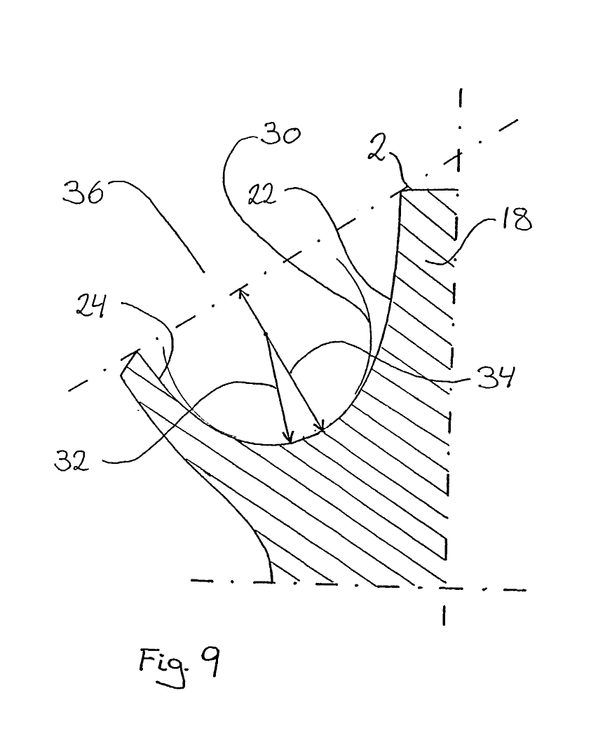

Below, the position of rest of the hand will be described on the assumption that a person's arms hang slack from the body, and the person's palms face toward the body, and the fingers hang slack, slightly flexed in all three joints. No opposition of the thumb is performed. Starting from this position, forearm and hand are moved up on a horizontal plane. Lying on the horizontal plane, the hand is in a position of rest. In this position the hand may be moved within an angular range which may be described as a neutral energy angle where the hand may be moved without using stationary energy. The pointing means supports the position of rest and ensures that the hand works within the neutral energy angle.

When working with traditional mice, including several more recent types, the wrist is subjected to a constant dorsal flexion which contributes to causing known mouse injuries. Also, the wrist is subjected to radial flexion and ulnar flexion, respectively. These flexions are among the most important causes of mouse injuries.

When the same mouse movements are to be made with the new pointing means, it will be necessary to move the entire hand and carry out volar or dorsal flexion of the wrist or movement of the forearm. Since volar or dorsal flexions of the wrist are natural movements, the cause of mouse injuries is eliminated.

1. A pointing means for a computer, consisting of a movement sensor having at least one button, said pointing means being ergonomically shaped to fill a human hand, said pointing means having engagement means for the thumb on one side, said side forming at least one side face on a projection (18), said projection having on at least one opposite face engagement means for the other fingers of the hand, characterized in, a lengthwise recess (6) with a thumb supporting face (20) having thumb support on a first side (22) and a second opposite side (24) where the recess (6) has an extension supporting the thumb as well as engagement means (10) for the ball of the thumb.

2. A pointing means for a computer according to claim 1, characterized in that the angle between the opposite face with engagement means for the other fingers of the hand, relative to a horizontal face is between 60 and 105 degrees.

3. A pointing means for a computer according to claim 2, characterized in that the angle between the opposite face with engagement means for the other fingers of the hand, relative to a horizontal face is between 65.5 and 85.5 degrees.

4. A pointing means for a computer according to claim 1, 2 or 3, characterized in that the recess (6) in one area (26) in at least one level of cut (28) has a shape approximately like a sector of a circle, said recess (6) having a depth of at least the same size as the radius of the sector of a circle, and said recess having an access opening of at least the same size as the diameter of the sector of a circle.

5. A pointing means for a computer according to claim 1, 2 or 3, characterized in that the recess (6) additionally has a recess which accommodates a scroll wheel (16) which may be operated by a thumb, said scroll wheel (16) simultaneously serving as a push-button.

6. A pointing means for a computer according to one of claims 1-5, characterized in that the pointing means is formed with an anatomically correct engagement face (10) for the thumb ball.

7. A pointing means for a computer according to one of claims 1-6, characterized in that the body (4) of the pointing means is formed with a projection (18) which separates the thumb and the forefinger.

8. A pointing means for a computer according to one of claims 1-7, characterized in that the pointing means is formed with a depression (12) for receiving the little finger.

9. A pointing means for a computer according to one of claims 1-8, characterized in that the pointing means is provided in a version for both the right hand and for the left hand.

10. A pointing means for a computer according to one of claims 1-9, characterized in that the pointing means is formed with means for wireless data transfer to a connected computer.

11. A pointing means for a computer according to one of claims 1-10, characterized in that the pointing means is provided in various sizes adapted to the size of a user's hand.
